(19) United States
(12) Patent Application Publication
(10) Pub. No.: US 2004/0093584 A1
(43) Pub. Date: May 13, 2004

(54) Facilitating software engineering and management in connection with a software development project according to a process that is compliant with a qualitatively measurable standard

(75) Inventor: Hien K. Le, Potomac, MD (US)

Correspondence Address: BAKER BOTTS L.L.P., 2001 ROSS AVENUE, SUITE 600, DALLAS, TX, 75201-2980, US

(73) Assignee: BearingPoint, Inc., a Delaware Corporation

(21) Appl. No.: 10/696,817

(22) Filed: Oct. 30, 2003

Related U.S. Application Data
(60) Provisional application No. 60/422,938, filed on Oct. 31, 2002.

(51) Int. Cl. G06F 9/44

(52) U.S. Cl. 717/103; 717/110

(57) ABSTRACT

In one embodiment, a system is provided for facilitating software engineering and management in connection with a software development project according to a process that is compliant with a qualitatively measurable standard. A server system is able to communicate with multiple client systems. A database associated with the server system contains resources accessible to the client systems using the server system in connection with one or more software development projects. The resources include first resources specifying multiple tasks to be performed within the process. The first resources specify, for each task, one or more of a description of the task, a description of how the task relates to the standard, one or more activities to be performed for the task, which personnel should perform the activities for the task, one or more deliverables to be generated for the task, one or more expected artifacts according to which the process will be measured against the standard, and an expected time to complete the task. The resources also include second resources including one or more templates. Each template may be customized in generating one or more deliverables for one or more tasks. The server system, at one or more times during a software development project, receives from a user associated with a client system a request for one or more resources, retrieves the requested resources from the database, and provides the requested resources to the user in connection with the software development project.

### RELATED APPLICATION

This application claims the benefit of U.S. Provisional Patent Application No. 60/422,938, filed Oct. 31, 2002.

### TECHNICAL FIELD OF THE INVENTION

This invention relates generally to software engineering and management and more particularly to facilitating software engineering and management in connection with a software development project according to a process that is compliant with a qualitatively measurable standard.

### BACKGROUND

The process of training, coaching, and supporting an organization that is trying to reach a particular maturity level (ML) of the Software Engineering Institute's (SEI's) Software Capability Maturity Model (SW-CMM) is often a time- and labor-intensive process fraught with trials, errors, and restarts. Typically, a software process improvement (SPI) specialist must work closely with a project team—giving instructions to the project team, waiting for the project team to carry out the instructions, instructing the project team to make any necessary corrections to work that has been done, and so on—until the project team fully complies with the SPI specialist's instructions. On average, it may take an organization forty-four months to reach an ML2 rating and an additional eighteen months to reach an ML3 rating. For business purposes and because many federal agencies require an organization to have at least an ML3 rating to even bid on agency requests for proposal (RFPs), it may be important for an organization to have at least an ML3 rating.

### SUMMARY OF THE INVENTION

According to the present invention, disadvantages and problems associated with software engineering and management may be reduced or eliminated.

In one embodiment, a system is provided for facilitating software engineering and management in connection with a software development project according to a process that is compliant with a qualitatively measurable standard. A server system is able to communicate with multiple client systems. A database associated with the server system contains resources accessible to the client systems using the server system in connection with one or more software development projects. The resources include first resources specifying multiple tasks to be performed within the process. The first resources specify, for each task, one or more of a description of the task, a description of how the task relates to the standard, one or more activities to be performed for the task, which personnel should perform the activities for the task, one or more deliverables to be generated for the task, one or more expected artifacts according to which the process will be measured against the standard, and an expected time to complete the task. The resources also include second resources including one or more templates. Each template may be customized in generating one or more deliverables for one or more tasks. The server system, at one or more times during a software development project, receives from a user associated with a client system a request for one or more resources, retrieves the requested resources from the database, and provides the requested resources to the user in connection with the software development project.

Particular embodiments of the present invention may provide one or more technical advantages. As an example, particular embodiments may reduce time requirements associated with reaching one or more particular MLs of a CMM (such as SEI's SW-CMM). Particular embodiments may facilitate a software project's compliance with one or more MLs. Particular embodiments may provide a software process that is instrumented. According to an instrumented software process, process descriptions, templates, and other tools may be provided to users so that the users do not have to create those tools themselves. Particular embodiments may provide a software process that is end-to-end. An end-to-end software process may encompasses both an organizational point of view and a project point of view. Particular embodiments may provide a software process that complies with one or more versions of a CMM. One or more tasks in the software process may specifically address specific key practices (KPs) of one or more versions of the CMM. Certain embodiments may provide all, some, or none of these technical advantages. Certain embodiments may provide one or more other technical advantages, one or more of which may be readily apparent to those skilled in the art from the figures, descriptions, and claims herein.

### BRIEF DESCRIPTION OF THE DRAWINGS

To provide a more complete understanding of the present invention and the features and advantages thereof, reference is made to the following description, taken in conjunction with the accompanying drawings, in which:

FIG. 1 illustrates an example system facilitating software engineering and management in connection with a software development project according to a process that is compliant with a qualitatively measurable standard;

FIG. 2 illustrates an example derivation of example tasks from an example ML;

FIG. 3 illustrates an example web page providing access to an example resource set for ML compliance;

FIG. 4 illustrates an example resource for tailoring an organizational standard software process (OSSP) to a particular software project;

FIG. 5 illustrates an example tailoring request form; and

FIG. 6 illustrates an example method for facilitating software engineering and management in connection with a software development project according to a process that is compliant with a qualitatively measurable standard.

### DESCRIPTION OF EXAMPLE EMBODIMENTS

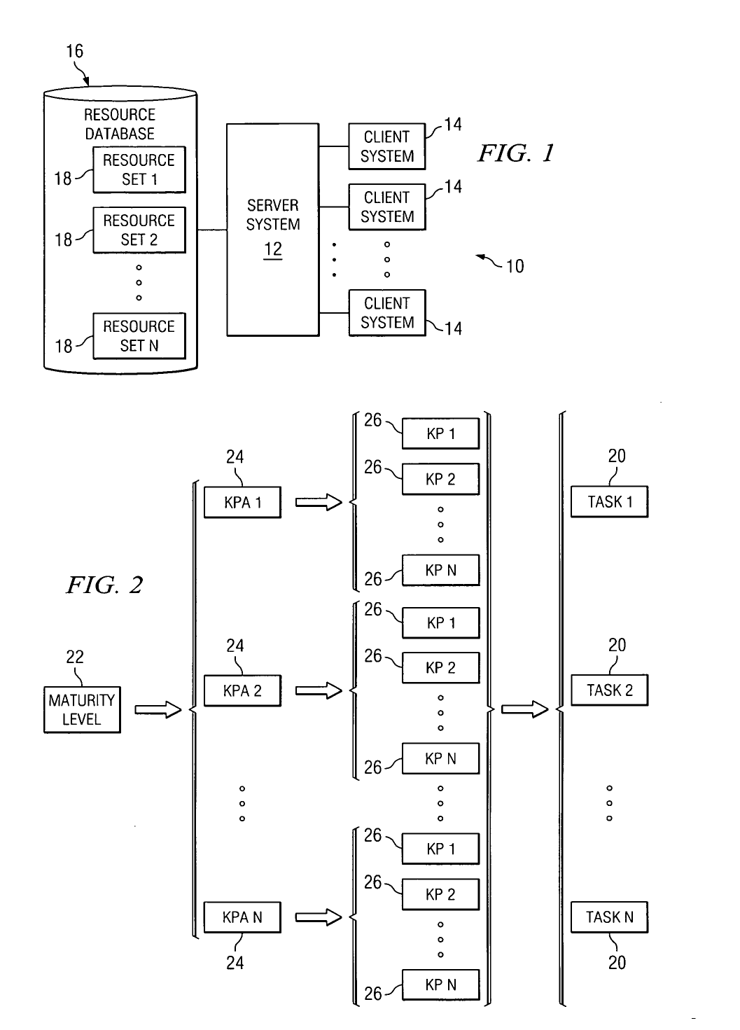

FIG. 1 illustrates an example system 10 for facilitating software engineering and management in connection with a software development project according to a process that is compliant with a qualitatively measurable standard. An example of a qualitatively measurable standard includes one or more MLs of an SW-CMM, such as the SEI's SW-CMM. An ML of an SW-CMM may include multiple key process areas (KPAs). A KPA may be an area of focus for improving an organization's software processes. A process may include a sequence of steps performed for a given purpose (such as software development). An organization may include an entity (such as an enterprise) that undertakes projects (such as software development projects). Associated with a KPA are goals and common features. A goal may be associated with enhancing process capabilities, and an organization may be required to achieve all goals associated with a KPA to satisfy the KPA. A common feature associated with a KPA may be an attribute that indicates whether an organization has implemented the KPA. Associated with a common feature of a KPA are one or more KPs that include activities, infrastructure, or both that contribute to reaching goals associated with the KPA. A KP may include one or more subpractices, according to particular needs.

As an example and not by way of limitation, an organization that has reached ML2 of the SEI's SW-CMM is capable of successfully planning, performing, and managing software projects. In addition, the organization has a software process that is repeatable. An organization that has reached ML3 of the SEI's SW-CMM has derived, from past successful software projects, “best practices” for planning, performing, and managing software projects. In addition, the organization has documented these best practices in an OSSP. An OSSP may include an operational definition of a best process that guides establishment of a common software process across software projects of an organization and a description of fundamental software-process elements that are to be incorporated into projects' defined software processes (PDSPs) of the organization.

In particular embodiments, an OSSP may facilitate implementation of KPs associated with ML2 and KPs associated with ML3. The OSSP may include more or less generic tasks (and subtasks) that may be carried out in a particular software project as is or after tailoring to the particular software project. The tasks of the OSSP may be traceable to KPs of one or more MLs to provide compliance with those MLs. In particular embodiments, the OSSP provides traceability to KPs of one or more MLs of the SEI's CMM-Integrated (CMMI) for compliance with the SEI's CMMI. The OSSP may support any suitable MLs. In particular embodiments, the OSSP may support ML2 and ML3 of the SEI's SW-CMM. In particular embodiments, the OSSP may also support ML4 and ML5 of the SEI's SW-CMM.

A PDSP may be an instantiation of an OSSP of an organization and may correspond to specific characteristics of a particular software project of the organization. A software project carried out according to a PDSP derived from an OSSP that is traceable to one or more MLs may comply with those MLs. The PDSP may include an operational definition of a software process associated with the software project. The PDSP may be described in terms of software standards, procedures, tools, and methods. In an organization that has reached ML3 of the SEI's SW-CMM, for software projects that the organization undertakes, PDSPs are derived and tailored from an OSSP of the organization.

System 10 includes a server system 12 that provides one or more users at one or more client systems 14 access to one or more resource databases 16 that include one or more resource sets 18. The components of system 10 may communicate with each other using one or more links that may each include one or more computer buses, local area networks (LANs), metropolitan area network (MANs), wide area networks (WANs), portions of the Internet, or other wireline, optical, wireless, or other links. Server system 12 may include one or more appropriate computer systems (which may be geographically separated from each other) that may collectively receive a resource request from a client system 14 and, in response to the resource request, access one or more resources from one or more resource sets 18 and communicate the accessed resources to client system 14. In particular embodiments, system 12 may receive project documentation, work product, or other information from client system 14 and store the information at resource database 16. Such information may be used to obtain certification associated with one or more MLs of an SW-CMM, as described more fully below. A client system 14 may include one or more computer systems associated with an organization that may provide one or more users access to server system 12. The computer systems of client system 14 may be distributed throughout the organization and may, in particular embodiments, be geographically separated from each other.

Resource database 16 may include one or more database systems that may collectively contain one or more resource sets 18. In particular embodiments, the database systems of resource database 16 may be geographically separated from each other. A resource set 18 in resource database 16 may include one or more resources that may be used to facilitate software engineering and management in connection with a software development project according to a process that is compliant with a qualitatively measurable standard. As an example and not by way of limitation, a resource set 18 may include information specifying one or more tasks that an organization may execute to reach one or more particular MLs of SEI's SW-CMM, as described more fully below. In particular embodiments, a resource set 18 may include an OSSP that facilitates compliance with one or more MLs of a CMM. In particular embodiments, resource set 18 may include one or more tools for tailoring an OSSP to a particular software project to generate a PDSP for the particular software project, as described more fully below.

FIG. 2 illustrates an example derivation of tasks from an example ML 22. In particular embodiments, ML 22 may include ML2, ML3, or other suitable ML of SEI's SW-CMM or CMMI (or both) or other CMM. As described above, ML 22 may include one or more KPAs 24 and each KPA 24 may, in turn, include one or more KPs 26. For each KPA 24, tasks 20 that address KPs 26 of KPA 24 may be identified. A task 20 may include one or more subtasks, according to particular needs. Reference to a KP 26 may include one or more subpractices of KP 26, where appropriate. To identify one or more tasks 20 that address a KP 26, one or more policies associated with KP 26 may be identified. In addition, one or more proofs, artifacts, or other resources for demonstrating compliance with a CMM may be identified. One or more tasks 20 that address KP 26 may be derived from these identified policies, proofs, and artifacts. In particular embodiments, tasks 20 may each relate to one or more of the following: tools, checklists, templates, procedures, tasks, methods, activities, processes, standards, and policies. In particular embodiments, tasks 20 may each correspond (and be traceable) to one or more particular KPAs 24. In addition to tasks 20, task collaterals associated with tasks 20 may also be identified. Task collaterals may include implementation aids (such as task descriptions for compliance with ML 22, templates, checklists policy statements, training and presentation materials, software tools, sample work products, and other implementation aids) and other resources. In particular embodiments, for each identified task collateral, CMM, Institute of Electrical and Electronics Engineers (IEEE), and other standards and sources related to the task collateral may be reviewed, a task collateral format identification scheme may be defined, and one or more task collateral templates may be created.

In particular embodiments, to facilitate an organization's or a software project's compliance with multiple MLs 22, multiple MLs 22 may be combined with each other for purposes of identifying tasks 20. As an example and not by way of limitation, a total of three hundred fifteen tasks 20 may be identified for all KPAs 24 of ML2 of the SEI's SW-CMM and all KPAs 24 of ML3 of the SEI's SW-CMM. In particular embodiments, tasks 20 may be consolidated into a set of “supertasks” to reduce redundancies across tasks 20 and to streamline compliance with one or more MLs 22. As an example and not by way of limitation, three hundred fifteen tasks 20 for ML2 and ML3 of SEI's SW-CMM may be consolidated into the following seven supertasks: (1) establishing an organizational-level SPI team; (2) identifying ML3 gaps; (3) establishing an engagement-level SPI implementation infrastructure; (4) developing a PDSP and plans; (5) carrying out the PDSP and plans; (6) requesting and obtaining support from a Public Services Consulting (PSC) Software Engineering Process Group (SEPG) as needed; and (7) requesting and taking an ML3 appraisal from the SPC SEPG. After an organization or software project team has carried out these supertasks, the PSC SEPG may provide monthly status reports on ML3 SPI efforts by the organization or software project team to a PSC Management Steering Group. In particular embodiments, resources associated with one or more of these supertasks may be contained in one or more resource sets 18 in resource database 16, as described more fully below.

In particular embodiments, establishing an engagement-level SPI implementation infrastructure may include: establishing required groups for ML2 and ML3 and assigning responsibilities; creating and disseminating policies associated with ML2 and ML3; training software project team members on processes associated with ML2 and processes associated with ML3; providing required training; and providing required orientations. In particular embodiments, developing a PDSP and plans may include: identifying a software life cycle model; tailoring a PDSP for a particular software project from an OSSP; developing and managing estimates; developing plans for ML2 and ML3; managing and controlling the developed plans for ML2 and ML3; and distributing the developed plans for ML2 and ML3. In particular embodiments, performing a PDSP may include: performing one or more software engineering tasks; performing one or more software management tasks; performing one or more measurement and analysis tasks; and performing one or more verification tasks.

In particular embodiments, tasks 20 associated with an ML 22 may constitute an OSSP that an organization may use to implement ML 22. In addition or as an alternative, software project teams in the organization may use the OSSP to generate PDSPs for particular software projects. The OSSP may include task descriptions, task collaterals, and other resources associated with tasks 20. In particular embodiments, the OSSP may include tasks 20 derived from multiple MLs 22. In these embodiments, a single OSSP that includes tasks 20 may be used to implement MLs 22. In addition or as an alternative, the OSSP may be used to generate PDSPs for particular software projects. In particular embodiments, an OSSP may include supertasks instead of tasks 20, which may reduce redundancies in the OSSP, as well as streamline the OSSP. As described more fully below, one or more resource sets 18 in resource database 16 may contain the OSSP (and associated task collaterals and other resources), which may be made available to one or more users at one or more client systems 14.

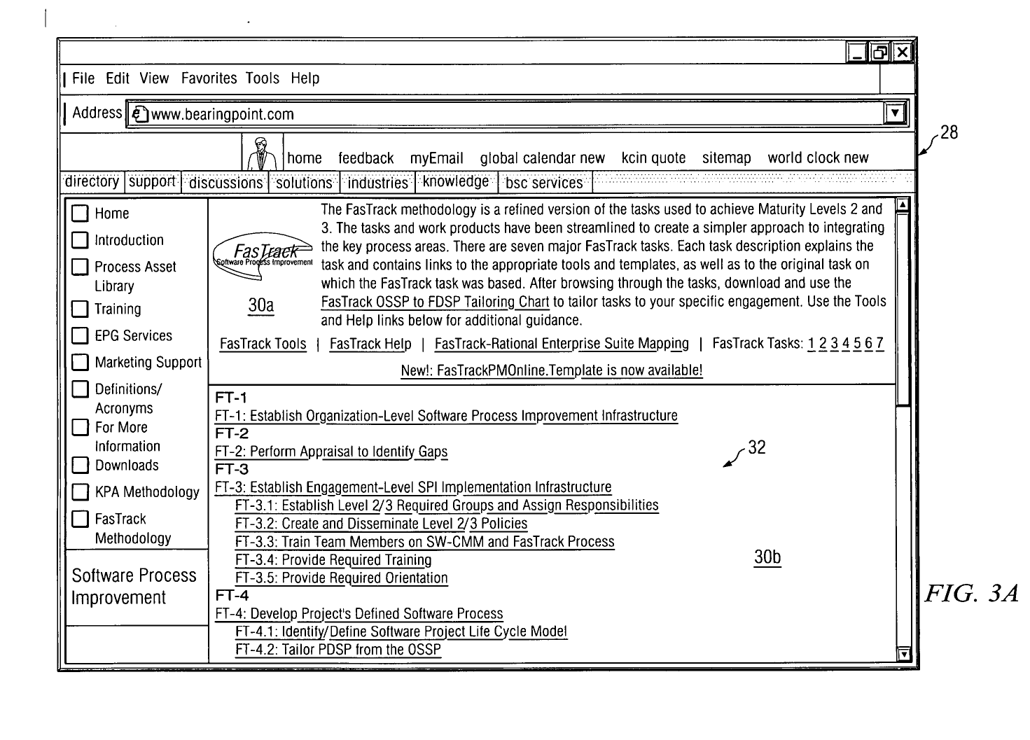

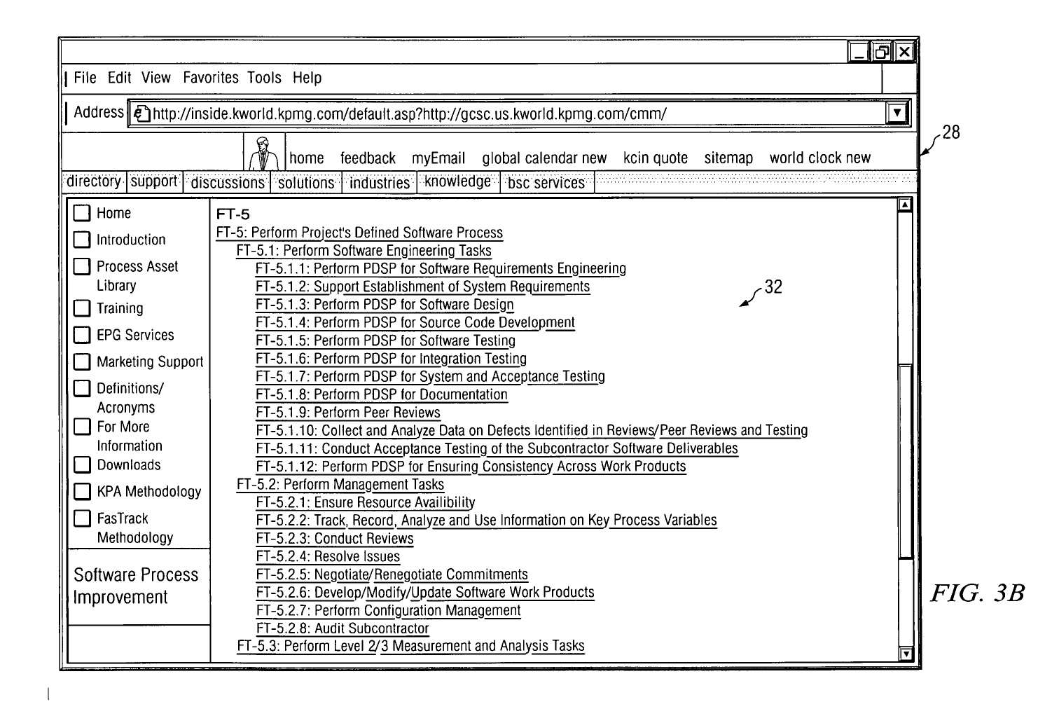

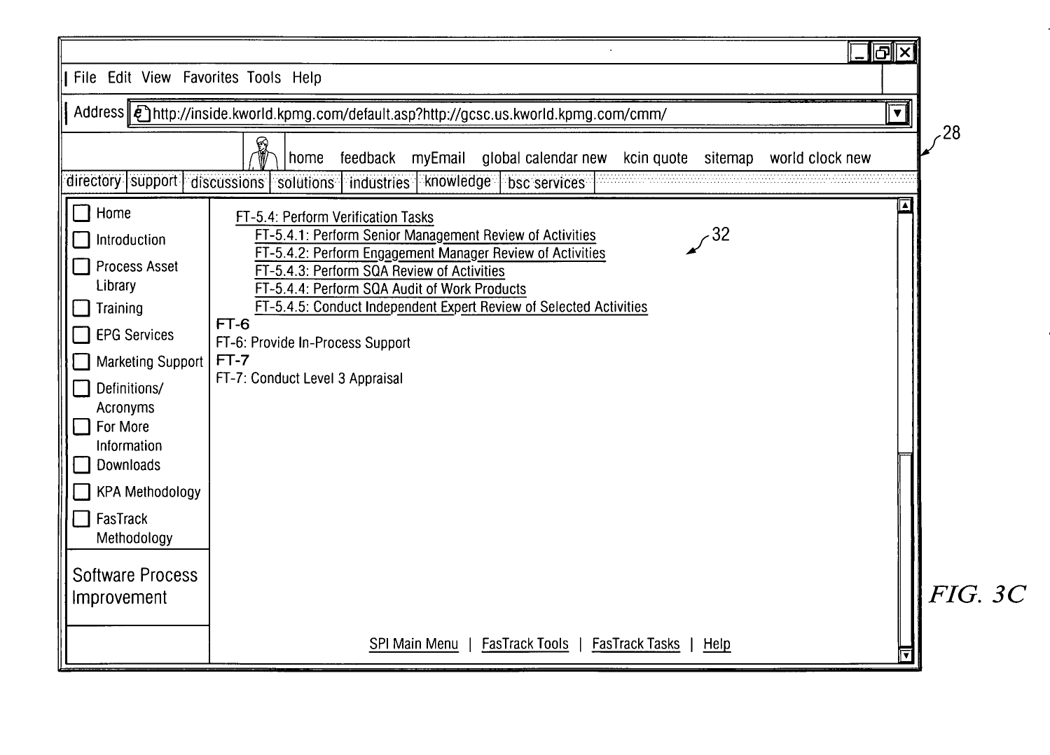

FIG. 3 illustrates an example web page 28 providing access to an example resource set 18 for compliance with ML2 and ML3 of the SEI's SW-CMM. Resource set 18 includes an OSSP and associated resources for compliance with ML2 and ML3 of the SEI's SW-CMM. Web page 28 includes a first area 30a that provides a summary of resource set 18. Web page 28 also includes a second area 30b that contains links 32 to particular resources in resource set 18. Web page 28 includes multiple levels of links 32. A first level includes links 32 to resources associated with the seven supertasks described above. With respect to certain supertasks, a second level of links 32 includes links 32 to resources associated with certain components of those supertasks. As an example, the third supertask described above-establishing an engagement-level SPI implementation infrastructure-includes five components: (1) establishing ML2 - and ML3 -required groups and assigning responsibilities; (2) creating and disseminating ML2 and ML3 policies; (3) training team members on one or more SW-CMM processes; (4) providing required training; and (5) providing required orientation. Each of these components has a link 32 in web page 28 to one or more resources associated with the component. With respect to certain supertasks, a third level of links 32 includes links 32 to particular elements of components of those supertasks.

A user at a client system 14 may click on or otherwise select a link 32 in web page 28 to gain access to one or more resources associated with the supertask, component, or element designated in link 32. When the user selects link 32, server system 12 may access the one or more resources and communicate the one or more resources to the user. As an example and not by way of limitation, server system 12 may communicate the one or more resources to the user in one or more hyper text markup language (HTML) files. As described above, the communicated resources may include one or more of the following: descriptions of one or more tasks 20 (or subtasks) or supertasks (or components or elements of supertasks); one or more task collaterals; one or more templates; and one or more other suitable resources. In particular embodiments, the resources accessible through web page 28 may collectively facilitate implementation of an OSSP in an organization. In addition or as an alternative, these resources may facilitate the development and implementation of a PDSP for a particular software project of the organization.

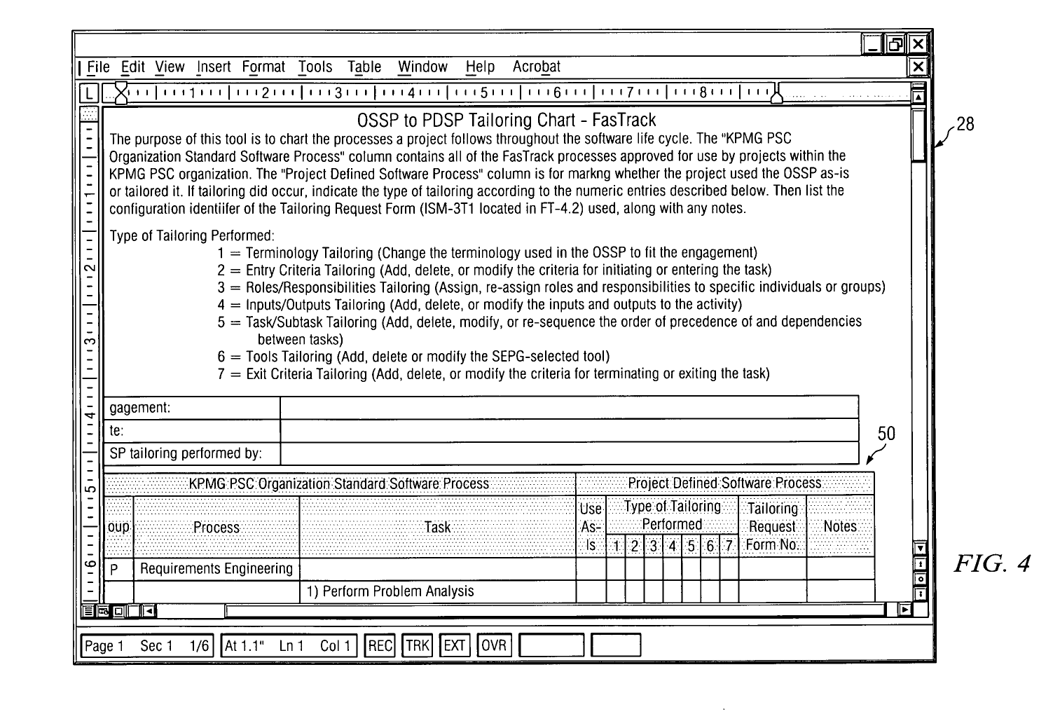

FIG. 4 illustrates an example resource for tailoring an OSSP to a particular software project to generate a PDSP. The resource includes a chart 50 that lists OSSP tasks that may be used as is in a particular software project or tailored to the particular software project. One or more resource sets 18 may include one or more instances of chart 50. One or more aspects of an OSSP may provide an inadequate fit to one or more specific conditions of a particular software project. As an example and not by way of limitation: terminology may be wrong; inputs, outputs and entry and exit criteria may not exist; subtask attributes (such as existence, precedence, and dependencies) may be too detailed; roles and responsibilities may not be present; or tools or other resources may not be available. In addition, for purposes of increasing ownership and understanding of a particular software process, tailoring may define process ownership and enhance process understanding.

Tailoring criteria may be used to tailor an OSSP to a particular software project. A first tailoring criterion may include appropriateness. This may encompass the appropriateness of a task in light of the client, one or more purposes of the software project, the software project team, and one or more resource restraints (such as time, money, people, and tools.). A second tailoring criterion may include justifiability. Tasks should not be cut, replaced, or added without justification. A third tailoring criterion may include actionability. According to this tailoring criterion, tailoring should result in a better software process. According to a fourth tailoring criterion, compliance with SW-CMM ML3 (or one or more other MLs) should be maintained

In particular embodiments, a nine-step process may be used to tailor an OSSP to a particular software project. OSSP attributes that may be subject to tailoring may include: terminology; inputs, outputs, and entry and exit criteria; subtasks (such as existence, precedence, and dependencies); roles and responsibilities; and tools. Tailoring mechanics may include adding, deleting, and modifying tasks and rearranging subtask ordering and dependency. According to this tailoring process, a statement of work (SOW), proposal, or both may first be reviewed. This may include identifying high-level requirements pertaining to a software process, such as required or implied software lifecycle model, phases and deliverables, and technology. Next, a software lifecycle model may be selected. The selected software lifecycle model (SLCM) may be a software lifecycle model that is particularly appropriate to the software project. An SLCM may have phases, input to and output from those phases, and an ordering relationship among those phases. According to the tailoring process, inputs and outputs of the lifecycle phases may then be defined.

Next, OSSP components may be mapped to particular lifecycle phases. This may include mapping OSSP software engineering tasks to phases of the SLCM. As an example, requirements analysis may be mapped to the OSSP's requirements engineering within the software engineering tasks. As another example, design may be mapped to the OSSP's design task within the software engineering tasks. OSSP software management tasks may contain most, if not all, non-development tasks of the SLCMs. As an example, conduct-critical design review may be a review task. OSSP details may then be tailored to the particular software project, which may include: tailoring terminology; tailoring task inputs and outputs; tailoring task entry and exit criteria; adding, deleting, and modifying subtasks; tailoring task workflow; tailoring task roles and responsibilities; and tailoring tools.

Tailoring terminology may encompass using engagement-specific language rather than OSSP language. Tailoring task entry and exit criteria may encompass determining whether to initiate or terminate tasks sooner or later than normal. Subtasks may be added, deleted, or modified based on tailoring of inputs and outputs. Tailoring task workflow may encompass modifying order of precedence and dependency between particular sub-tasks. Tailoring task roles and responsibilities may include deciding who will do what in the particular software project. Tailoring tools may include reviewing, recommending, and selecting tools to perform certain tasks, especially software engineering tasks. As an example, a tool set may include RATIONAL ROSE for software engineering, VISUAL SOURCE SAFE for software configuration management (SCM), and SOFTWARE LIFE CYCLE MANAGEMENT (SLIM) for size, effort, and cost estimating. Next, tailoring may be documented and any needed waivers may be requested from the SEPG. This may include documenting and reviewing the PDSP and obtaining approval of the PDSP from the SEPG prior to distribution and use. SEPG approval of the waivers may then be secured. Next, the completed PDSP may be reviewed, and the PDSP may then be finalized and distributed.

In chart 50, for each task, there are fields for indicating whether the task is to be used as is in the software project or to be tailored according to one or more particular aspects of the software project. In addition, there are fields for indicating what type of tailoring is to be implemented if the task is to be tailored. As an example and not by way of limitation, there are seven different types of tailoring that may be implemented. A first type includes terminology tailoring. This may include changing terminology used in the OSSP to fit the particular software project. A second type of tailoring includes entry criteria tailoring. This may include adding, deleting, or modifying criteria for initiating or entering a task or sub-task. A third type of tailoring includes role and responsibility tailoring. This may include assigning and reassigning roles and responsibilities to specific individuals or groups. A fourth type of tailoring is input and output tailoring. This includes adding, deleting, and modifying inputs to and outputs from a task. A fifth type of tailoring is task and sub-task tailoring. This may include adding, deleting, modifying, or resequencing order of precedence of tasks and dependencies between tasks. A sixth type of tailoring includes tools tailoring. This may include adding, deleting, or modifying an SEPG-selected tool. A seventh kind of tailoring includes exit criteria tailoring. This may include adding, deleting, or modifying criteria for terminating or exiting a task or sub-task. Chart 50 may also include, for each task, a field for indicating a tailoring request form used in connection with tailoring performed with respect to the task, as described more fully below. In addition, chart 50 may include, for each task, a field for indicating one or more user notes associated with the task.

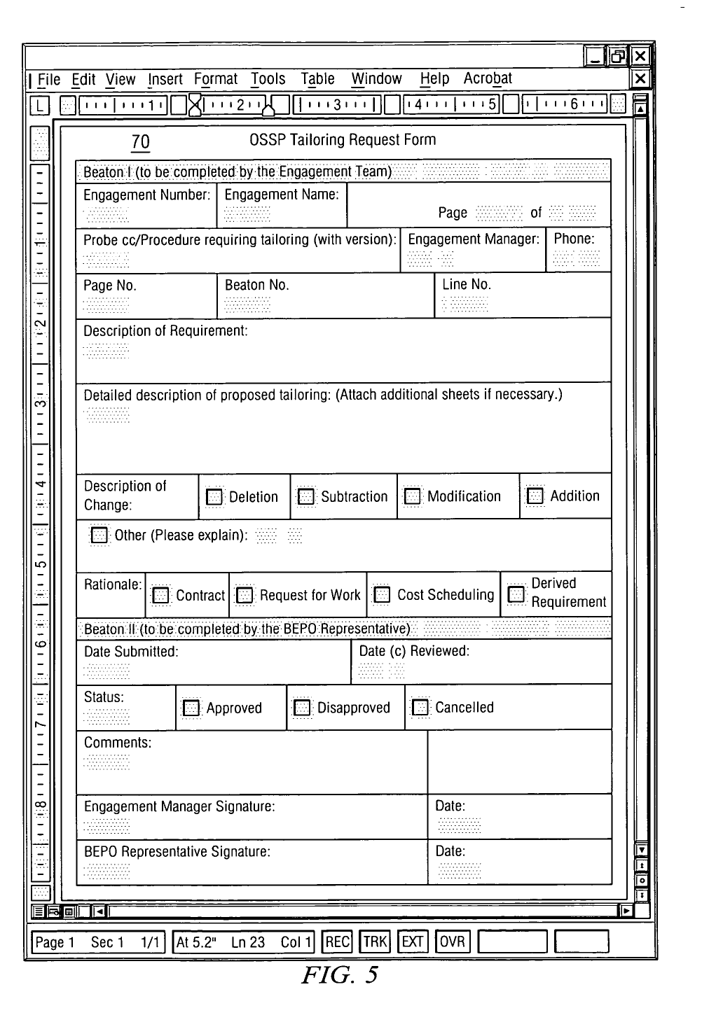

FIG. 5 illustrates an example tailoring request form 70. One or more resource sets 18 may contain a request form 70. When a user tailors a task or other aspect of an OSSP to a particular software project, the user may describe in form 70 the tailoring that the user implemented. Form 70 may be used to document the implemented tailoring for verification and other suitable purposes, as described above. As an example, tailoring request form 70 may be filled out, stored in resource database 16 in connection with a particular software project, and used to obtain SEPG approval of a PDSP for the particular software project.

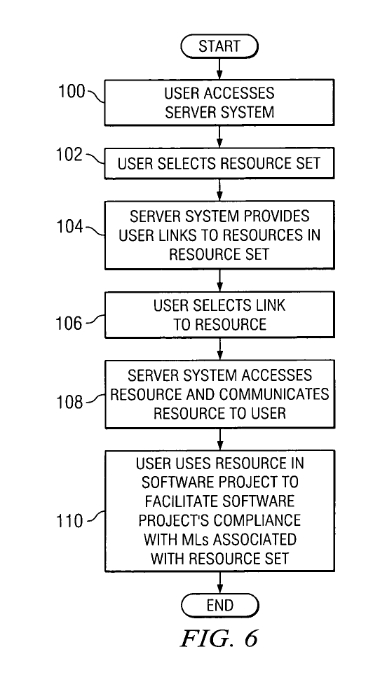

FIG. 6 illustrates an example method for facilitating software engineering and management in connection with a software development project according to a process that is compliant with a qualitatively measurable standard. The method begins at step 100 where a user at a client system 14 accesses server system 12. At step 102, the user selects a particular resource set 18 in resource database 16. In particular embodiments, server system may provide a menu of resource sets 18 to the user to enable the user to make this selection. At step 104, server system 12 provides user with links 32 to particular resources in resource set 18 selected by the user. At step 106, the user selects a particular link 32 to a particular resource in resource set 18. At step 108, server system 12 accesses the particular resource and communicates the particular resource to the user. At step 110, the user uses the particular resource in connection with a software project to facilitate the software project's compliance with one or more MLs associated with resource set 18, at which point the method ends. One or more steps in the method illustrated in FIG. 6 may be repeated over the course of the software project to facilitate compliance with those MLs with respect to certain aspects of the software project.

Although the present invention has been described with several embodiments, myriad changes, variations, alterations, transformations, and modifications may be suggested to one skilled in the art, and it is intended that the present invention encompass such changes, variations, alterations, transformations, and modifications as fall within the scope of the appended claims. The present invention is not intended to be limited, in any way, by any statement in the specification that is not reflected in the claims.

What is claimed is:

1. A system facilitating software engineering and management in connection with a software development project according to a process that is compliant with a qualitatively measurable standard, comprising:
a server system operable to communicate with a plurality of client systems;
a database associated with the server system and containing resources accessible to the client systems using the server system in connection with one or more software development projects, the resources comprising at least:
first resources specifying a plurality of tasks to be performed within the process and specifying for each task one or more of:
a description of the task;
a description of how the task relates to the standard;
one or more activities to be performed for the task;
which personnel should perform the activities for the task;
one or more deliverables to be generated for the task;
one or more expected artifacts according to which the process will be measured against the standard; and
an expected time to complete the task; and
second resources comprising one or more templates, each template operable to be customized in generating one or more deliverables for one or more tasks;
the server system operable to, at one or more times during a software development project:
receive from a user associated with a client system a request for one or more resources;
retrieve the requested resources from the database; and
provide the requested resources to the user in connection with the software development project.

2. The system of claim 1, wherein the standard comprises one or more maturity levels, each maturity level comprising a plurality of key practice areas, each key practice area comprising a plurality of goals, each goal comprising a plurality of key practices.

3. The system of claim 2, wherein the standard comprises the Software Engineering Institute's Software Capability Maturity Model (SEI/SW-CMM).

4. The system of claim 2, wherein the description of how the task relates to the standard comprises an identification of one or more maturity levels, key practice areas, goals, and key practices to which the task relates.

5. The system of claim 1, wherein each template comprises one of:
a standard template generic to a plurality of software development projects within an enterprise; and
a deliverable generated in connection with a previous software development project.

6. The system of claim 1, wherein the server system is further operable to, at one or more times during a software development project:
receive a deliverable generated in connection with the software development project;
store at least a portion of the deliverable in the database; and
make the stored portion of the deliverable accessible to the client systems for use, with or without customization, in connection with subsequent software development projects.

7. A method facilitating software engineering and management in connection with a software development project according to a process that is compliant with a qualitatively measurable standard, comprising:
providing a plurality of client systems with access to a database associated with a server system in connection with one or more software development projects, the database containing resources comprising at least:
first resources specifying a plurality of tasks to be performed within the process and specifying for each task one or more of:
a description of the task;
a description of how the task relates to the standard;
one or more activities to be performed for the task;
which personnel should perform the activities for the task;
one or more deliverables to be generated for the task;
one or more expected artifacts according to which the process will be measured against the standard; and
an expected time to complete the task; and
second resources comprising one or more templates, each template operable to be customized in generating one or more deliverables for one or more tasks;
at one or more times during a software development project:
receiving from a user associated with a client system a request for one or more resources;
retrieving the requested resources from the database; and
providing the requested resources to the user in connection with the software development project.

8. The method of claim 7, wherein the standard comprises one or more maturity levels, each maturity level comprising a plurality of key practice areas, each key practice area comprising a plurality of goals, each goal comprising a plurality of key practices.

9. The method of claim 8, wherein the standard comprises the Software Engineering Institute's Software Capability Maturity Model (SEI/SW-CMM).

10. The method of claim 8, wherein the description of how the task relates to the standard comprises an identification of one or more maturity levels, key practice areas, goals, and key practices to which the task relates.

11. The method of claim 7, wherein each template comprises one of:
a standard template generic to a plurality of software development projects within an enterprise; and
a deliverable generated in connection with a previous software development project.

12. The method of claim 7, further comprising, at one or more times during a software development project:
receiving a deliverable generated in connection with the software development project;
storing at least a portion of the deliverable in the database; and
making the stored portion of the deliverable accessible to the client systems for use, with or without customization, in connection with subsequent software development projects.

13. Software facilitating software engineering and management in connection with a software development project according to a process that is compliant with a qualitatively measurable standard, the software being embodied in computer readable media and when executed operable to:
provide a plurality of client systems with access to a database associated with a server system in connection with one or more software development projects, the database containing resources comprising at least:
first resources specifying a plurality of tasks to be performed within the process and specifying for each task one or more of:
a description of the task;
a description of how the task relates to the standard;
one or more activities to be performed for the task;
which personnel should perform the activities for the task;
one or more deliverables to be generated for the task;
one or more expected artifacts according to which the process will be measured against the standard; and
an expected time to complete the task; and
second resources comprising one or more templates, each template operable to be customized in generating one or more deliverables for one or more tasks;
at one or more times during a software development project:
receive from a user associated with a client system a request for one or more resources;
retrieve the requested resources from the database; and
provide the requested resources to the user in connection with the software development project.

14. The software of claim 13, wherein the standard comprises one or more maturity levels, each maturity level comprising a plurality of key practice areas, each key practice area comprising a plurality of goals, each goal comprising a plurality of key practices.

15. The software of claim 14, wherein the standard comprises the Software Engineering Institute's Software Capability Maturity Model (SEI/SW-CMM).

16. The software of claim 14, wherein the description of how the task relates to the standard comprises an identification of one or more maturity levels, key practice areas, goals, and key practices to which the task relates.

17. The software of claim 13, wherein each template comprises one of:
a standard template generic to a plurality of software development projects within an enterprise; and
a deliverable generated in connection with a previous software development project.

18. The software of claim 13, further operable to, at one or more times during a software development project:
receive a deliverable generated in connection with the software development project;
store at least a portion of the deliverable in the database; and
make the stored portion of the deliverable accessible to the client systems for use, with or without customization, in connection with subsequent software development projects.

19. A system facilitating software engineering and management in connection with a software development project according to a process that is compliant with a qualitatively measurable standard, comprising:
means for providing a plurality of client systems with access to a database associated with a server system in connection with one or more software development projects, the database containing resources comprising at least:
first resources specifying a plurality of tasks to be performed within the process and specifying for each task one or more of:
a description of the task;
a description of how the task relates to the standard;
one or more activities to be performed for the task;
which personnel should perform the activities for the task;
one or more deliverables to be generated for the task;
one or more expected artifacts according to which the process will be measured against the standard; and
an expected time to complete the task; and
second resources comprising one or more templates, each template operable to be customized in generating one or more deliverables for one or more tasks;
means for, at one or more times during a software development project:
receiving from a user associated with a client system a request for one or more resources;
retrieving the requested resources from the database; and
providing the requested resources to the user in connection with the software development project.

20. A system facilitating software engineering and management in connection with a software development project according to a process that is compliant with the Software Engineering Institute's Software Capability Maturity Model (SEI/SW-CMM), the SEI/SW-CMM comprising one or more maturity levels, each maturity level comprising a plurality of key practice areas, each key practice area comprising a plurality of goals, each goal comprising a plurality of key practices, the system comprising:
a server system operable to communicate with a plurality of client systems;
a database associated with the server system and containing resources accessible to the client systems using the server system in connection with one or more software development projects, the resources comprising at least:
first resources specifying a plurality of tasks to be performed within the process and specifying for each task one or more of:
a description of the task;
an identification of one or more SEI/SW-CMM maturity levels, key practice areas, goals, and key practices to which the task relates;
one or more activities to be performed for the task;
which personnel should perform the activities for the task;
one or more deliverables to be generated for the task;
one or more expected artifacts according to which the process will be measured against the SEI/SW-CMM; and
an expected time to complete the task; and
second resources comprising one or more templates, each template operable to be customized in generating one or more deliverables for one or more tasks, each template comprising one of:
a standard template generic to a plurality of software development projects within an enterprise; and
at least a portion of a deliverable generated in connection with a previous software development project;
the server system operable to, at one or more times during a software development project:
receive from a user associated with a client system a request for one or more resources;
retrieve the requested resources from the database; and
provide the requested resources to the user in connection with the software development project.
the server system further operable to, at one or more times during a software development project:
receive a deliverable generated in connection with the software development project;
store at least a portion of the deliverable in the database; and
make the stored portion of the deliverable accessible to the client systems for use, with or without customization, in connection with subsequent software development projects.
